(19) United States
(12) Patent Application Publication
(10) Pub. No.: US 2026/0186154 A1
(43) Pub. Date: Jul. 2, 2026

(54) METHOD AND SYSTEM FOR GENERATING LOCATION INFORMATION IN GNSS SIGNAL SHADOW AREA

(71) Applicant: VESTELLALAB INC., Seoul (KR)

(72) Inventors: Yung Ji CHOI, Seoul (KR); Young Soo LEE, Seoul (KR); Sangsu JUNG, Seoul (KR)

(73) Assignee: VESTELLALAB INC., Seoul (KR)

(21) Appl. No.: 18/848,480

(22) PCT Filed: Mar. 25, 2024
(86) PCT No.: PCT/KR2024/003703

§ 371 Date: Sep. 18, 2024

(30) Foreign Application Priority Data
Apr. 12, 2023 (KR) 10-2023-0048029

(51) Int. Cl. G01S 19/48

(52) U.S. Cl. CPC G01S 19/485

(57) ABSTRACT

Provided is a method of generating location information in a GNSS signal shadow area. The method includes generating first location information based on an area relative-coordinate system corresponding to a GNSS signal shadow area, based on results that are measured by a predetermined positioning scheme with respect to a still or moving object placed in the GNSS signal shadow area, obtaining area location information according to the area relative-coordinate system and area GNSS information in a GNSS coordinate system, which is matched with the area location information, converting the first location information into second location information that is a virtual GNSS location value continuous to the GNSS, based on the results of matching between the area location information and the area GNSS information, and providing the converted second location information.

### BACKGROUND

### 1. Technical Field

The present disclosure relates to a method and system for generating location information in a global navigation satellite system (GNSS) signal shadow area.

### 2. Related Art

A GNSS is a satellite navigation system that provides a global location information service. The GNSS tracks a location by using signals transmitted through the receivers of satellites that are disposed above the earth and provides location information based on the location. The GNSS is a concept that embraces satellite navigation systems developed by various countries, such as Russia's GLONASS, Europe's Galileo, and China's BeiDou in addition to U.S.'s global positioning system (GPS).

The GNSS can guarantee the highest accuracy in location when an object is placed outdoors on the ground, but may have a problem with accuracy when the GNSS is used indoors. That is, if a signal is blocked as in a building or a basement, a GNSS receiver has a problem in that it cannot receive satellite signals. Furthermore, there is a problem in that location tracking accuracy is reduced due to the reflection of a signal attributable to a building, furniture, or other structures indoors. In addition, location accuracy is inevitably reduced because more time may be taken for a signal that is transmitted by the satellite to reach the GNSS receiver through an obstacle indoors.

Other indoor location measuring technologies for supplementing such a problem in an indoor GNSS shadow area have been developed. For example, an indoor location may be measured by using a wireless communication technology, such as Wi-Fi, Bluetooth, or RFID. In general, in these technologies, an indoor location is measured by using a device, such as an access point or a beacon that is installed within a building.

Furthermore, an image of a camera may be used in the indoor location measuring technology. In general, the camera may capture an image of an object or a scene and extract information on the location of an object through image processing.

As described above, in an indoor environment, information on the current location of an object may be provided by using various positioning technologies, but there is a problem in that the information is based on an individual building relative-coordinate system (hereinafter referred to as an “area relative-coordinate system”) not GNSS information.

As a result, if an objective location of a vehicle needs to be received in a GNSS signal shadow area, such as a parking lot, location information that is represented as a GNSS coordinate value needs to be provided, but there is a problem in that the identification and continuous utilization of objective location information are limited because GNSS positioning is impossible in the GNSS signal shadow area.

### SUMMARY

Various embodiments are directed to providing a method and system for generating location information in a GNSS signal shadow area, which can generate and provide virtual GNSS information of an object based on location information based on the area relative-coordinate system, which is generated according to a non-GNSS positioning scheme, even in an area in which GNSS information cannot be obtained, such as an indoor parking lot, a tunnel, a concrete jungle, an exhibition hall, or a shopping mall.

However, objects of the present disclosure to be achieved are not limited to the aforementioned object, and other objects may be present.

A method of generating location information in a GNSS signal shadow area according to a first aspect of the present disclosure includes generating first location information based on an area relative-coordinate system corresponding to a GNSS signal shadow area, based on results that are measured by a predetermined positioning scheme with respect to a still or moving object placed in the GNSS signal shadow area, obtaining area location information according to the area relative-coordinate system and area GNSS information in a GNSS coordinate system, which is matched with the area location information, converting the first location information into second location information that is a virtual GNSS location value continuous to the GNSS, based on the results of matching between the area location information and the area GNSS information, and providing the converted second location information.

In some embodiments of the present disclosure, the generating of the first location information based on the area relative-coordinate system may include generating the first location information of the still or moving object in the area relative-coordinate system, based on an image or sensing data that are obtained by a camera or a predetermined sensor installed in the GNSS signal shadow area.

In some embodiments of the present disclosure, the method may further include generating a map database by mapping area location information corresponding to the GNSS signal shadow area and GNSS information corresponding to the area location information.

In some embodiments of the present disclosure, the converting of the first location information into the second location information may include performing rotation conversion and size conversion on the first location information, based on the results of matching between a plurality of coordinate values included in the area location information according to the area relative-coordinate system and a plurality of GNSS values included in the area GNSS information in the GNSS coordinate system.

In some embodiments of the present disclosure, the converting of the first location information into the second location information may include converting the first location information into the second location information by performing approximation to which a finite element method or a finite difference method has been applied on the first location information in at least one of a case in which a total area of the GNSS signal shadow area is an area greater than a preset threshold and a case in which a shape of the GNSS signal shadow area does not satisfy a preset curvature condition.

In some embodiments of the present disclosure, the providing of the converted second location information may include providing the converted second location information by applying the approximation when a maximum possible error between results on which the approximation has not been applied and an actual location is greater than a preset technical requirement level value.

Furthermore, a system for generating location information in a global navigation satellite system (GNSS) signal shadow area includes memory in which a program for generating location information of a still or moving object placed in a GNSS signal shadow area has been stored and a processor configured to, when the program stored in the memory is executed, generate first location information based on an area relative-coordinate system corresponding to the GNSS signal shadow area based on results that are measured by a predetermined positioning scheme with respect to the still or moving object, obtain area location information according to the area relative-coordinate system and area GNSS information in the GNSS coordinate system, which is matched with the area location information, convert the first location information into second location information that is a virtual GNSS location value continuous to the GNSS, based on the results of matching between the area location information and the area GNSS information, and provide the converted second location information.

Furthermore, a computer program according to another aspect of the present disclosure executes the method of generating location information in a GNSS signal shadow area in association with a computer, that is, hardware, and is stored in a computer-readable recording medium.

Other details of the present disclosure are included in the detailed description and the drawings.

The embodiments of the present disclosure have an advantage in that a continuous GNSS-based service can be provided because GNSS information that is provided only outdoors can be provided by being converted into a virtual GNSS value even in a GNSS signal shadow area in which a GNSS signal is not received.

Various services, such as location-based advertising, safety management, indoor road guide, and indoor location tracking, can be provided through the provision of continuous GNSS information. That is, there are advantages in that a user can conveniently use a location-based service based on the GNSS even within a building and more efficient business management or safety management in a company or an institute is possible because an indoor moving path or location information can be managed and used based on the GNSS and integrated with an outdoor map.

Effects of the present disclosure which may be obtained in the present disclosure are not limited to the aforementioned effects, and other effects not described above may be evidently understood by a person having ordinary knowledge in the art to which the present disclosure pertains from the following description.

### BRIEF DESCRIPTION OF THE DRAWINGS

FIG. 1 is a flowchart illustrating a method of generating location information in a GNSS signal shadow area according to an embodiment of the present disclosure.

FIG. 2 is a diagram for describing contents in which first location information in a GNSS signal shadow area is generated in an embodiment of the present disclosure.

FIG. 3 is a diagram illustrating an example of building GNSS information in a GNSS coordinate system in an embodiment of the present disclosure.

FIG. 4 is a diagram for describing contents in which the first location information is converted into second location information in an embodiment of the present disclosure.

FIGS. 5A and 5B are diagrams for describing contents in which approximation is applied to the second location information according to a predetermined condition in an embodiment of the present disclosure.

FIG. 6 is a block diagram of a system for generating location information according to an embodiment of the present disclosure.

### DETAILED DESCRIPTION

Advantages and characteristics of the present disclosure and a method for achieving the advantages and characteristics will become apparent from the embodiments described in detail later in conjunction with the accompanying drawings. However, the present disclosure is not limited to embodiments disclosed hereinafter, but may be implemented in various different forms. The embodiments are merely provided to complete the present disclosure and to fully notify a person having ordinary knowledge in the art to which the present disclosure pertains of the category of the present disclosure. The present disclosure is merely defined by the claims.

Terms used in this specification are used to describe embodiments and are not intended to limit the present disclosure. In this specification, an expression of the singular number includes an expression of the plural number unless clearly defined otherwise in the context. The term “comprises” and/or “comprising” used in this specification does not exclude the presence or addition of one or more other elements in addition to a mentioned element. Throughout the specification, the same reference numerals denote the same elements. “And/or” includes each of mentioned elements and all combinations of one or more of mentioned elements. Although the terms “first”, “second”, etc. are used to describe various components, these elements are not limited by these terms. These terms are merely used to distinguish between one element and another element. Accordingly, a first element mentioned hereinafter may be a second element within the technical spirit of the present disclosure.

All terms (including technical and scientific terms) used in this specification, unless defined otherwise, will be used as meanings which may be understood in common by a person having ordinary knowledge in the art to which the present disclosure pertains. Furthermore, terms defined in commonly used dictionaries are not construed as being ideal or excessively formal unless specially defined otherwise.

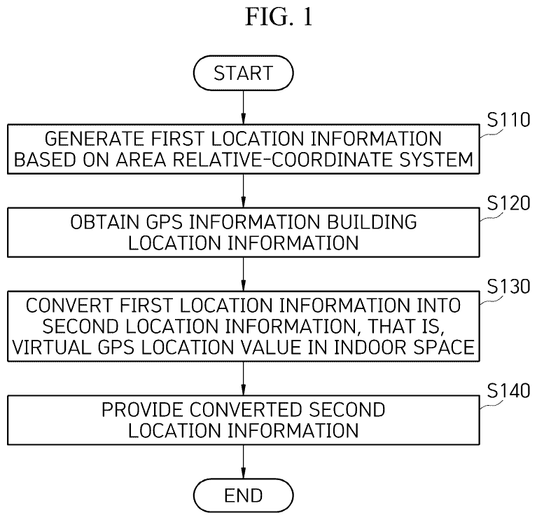

Hereinafter, a method of generating location information in a GNSS signal shadow area according to an embodiment of the present disclosure is described with reference to FIGS. 1 to 6.

FIG. 1 is a flowchart illustrating the method of generating location information in a GNSS signal shadow area according to an embodiment of the present disclosure. Steps illustrated in FIG. 1 may be understood as being performed by a system 100 for generating location information in a GNSS signal shadow area, but the present disclosure is not essentially limited thereto.

First, first location information based on an area relative-coordinate system corresponding to a GNSS signal shadow area is generated (S110) based on the results of the measurement of a still or moving object, which is placed in the GNSS signal shadow area, according to a predetermined positioning scheme. In this case, the GNSS signal shadow area may be an indoor space, for example, a building, but the present disclosure is not essentially limited thereto.

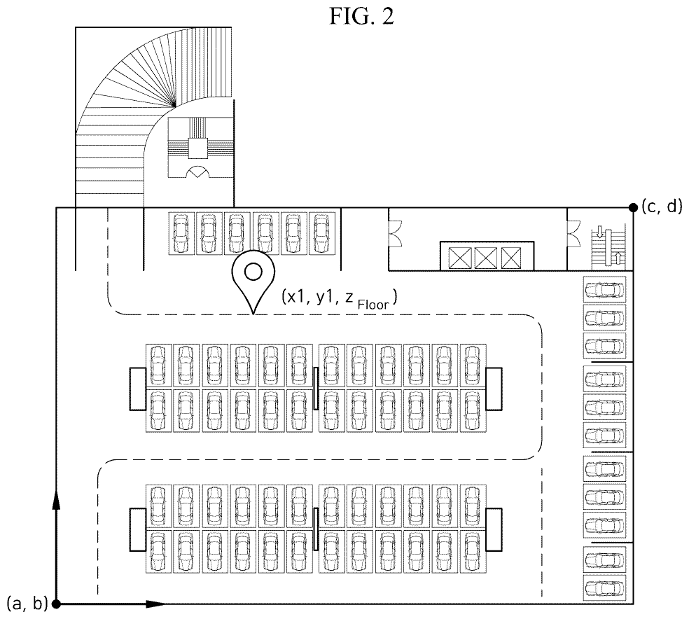

FIG. 2 is a diagram for describing contents in which first location information in a GNSS signal shadow area is generated in an embodiment of the present disclosure.

In an embodiment of the present disclosure, first location information (x₁, y₁, z) of a still or moving object based on an area relative-coordinate system may be generated based on an image or sensing data that are obtained through a camera or a predetermined positioning sensor installed in a GNSS signal shadow area.

In this case, if the location information of the object placed in the GNSS signal shadow area is indicated as the area relative-coordinate system by using the camera, for example, matching between an actual space and an image thereof may be performed through camera calibration, the object may be identified in a captured image or video, and coordinates in a three-dimensional (3-D) actual space may be then calculated based on a two-dimensional (2-D) location in an image of the object. Thereafter, the location information of the object may be indicated as the first location information that is represented as the area relative-coordinate system.

Furthermore, if the positioning sensor is used, the location of the object placed in the GNSS signal shadow area may be measured by using various positioning sensors, such as using a Bluetooth beacon, an ultrasonic sensor, or a laser sensor. For example, if the Bluetooth beacon is used, when the positioning sensor receives the signal of the beacon, the location of the object may be measured by analyzing the strength of the received signal. If ultrasonic waves or a laser is used, a distance from the object may be calculated based on the time that is taken for the ultrasonic waves or the laser to be returned after being reflected by the object, and the location of the object may be measured based on the distance.

As described above, in an embodiment of the present disclosure, a positioning scheme for an object that is placed in a GNSS signal shadow area is not limited to any one method. The first location information that is generated according to the positioning scheme may be converted into second location information, that is, a virtual GNSS location value. Continuous GNSS information for an object may be expressed although the object enters an outdoor GNSS signal shadow area.

Next, area location information according to the area relative-coordinate system and area GNSS information in a GNSS coordinate system, which is matched with the area location information, are obtained (S120).

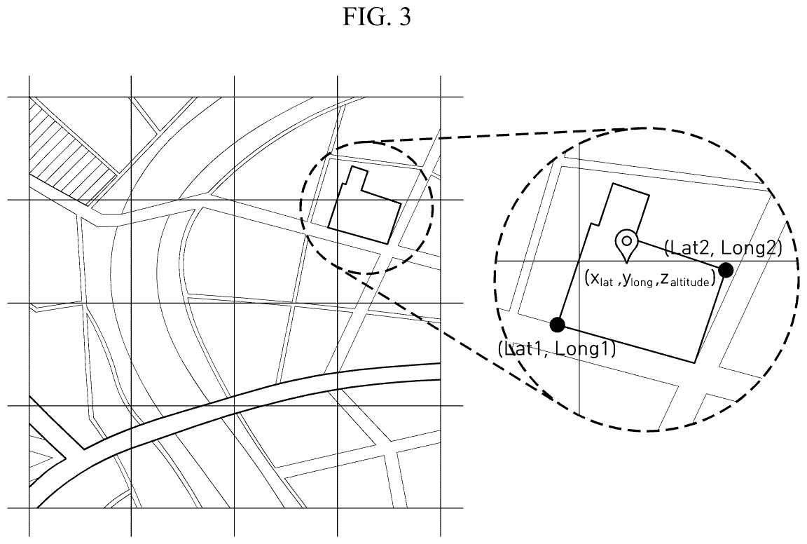

FIG. 3 is a diagram illustrating an example of building GNSS information in a GNSS coordinate system in an embodiment of the present disclosure.

In an embodiment, the area location information may include a plurality of coordinate values that is represented as an area relative-coordinate system. Preferably, the area location information is for matching a virtual GNSS value with a plurality of GNSS values included in area GNSS information. The plurality of coordinate values based on the area location information may be coordinate values that are measured at a location where a GNSS signal is received.

When the plurality of coordinate values based on the area location information is obtained, GNSS values (Lat1, Long1) and (Lat2, Long2) based on area GNSS information that is matched with corresponding coordinate values are obtained. In this case, in the description of the present disclosure, only latitude and longitude dimensions are taken as the coordinate values as an example, but this is merely an example and the coordinate values may include altitude information.

When the GNSS values based on the area GNSS information that is matched with the coordinate values based on the area location information are obtained as described above, a map database may be generated and managed by mapping area location information corresponding to the GNSS signal shadow area and area GNSS information corresponding to the area location information.

Next, the first location information in the GNSS signal shadow area is converted into the second location information (S130), that is, a virtual GNSS location value that is continuous to the GNSS, based on the results of the matching between the area location information and building GNSS information. The converted second location information is provided (S140).

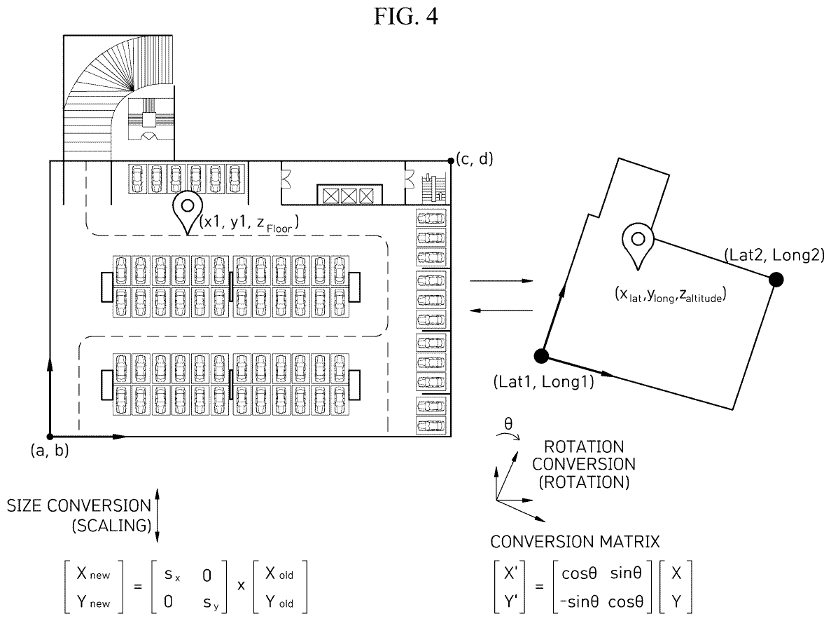

FIG. 4 is a diagram for describing contents in which the first location information is converted into the second location information in an embodiment of the present disclosure.

In an embodiment of the present disclosure, rotation conversion (ROTATION) and size conversion (SCALING) are performed on the first location information, based on the results of matching between the plurality of coordinate values included in the area location information according to the area relative-coordinate system and the plurality of GNSS values included in the area GNSS information of the GNSS coordinate system.

In this case, the rotation conversion is a conversion task that is performed in order to let the area location information and the area GNSS information to correspond to each other. That is, when the area location information is (a, b) and (c, d) and the area GNSS information is (Lat1, Long1) and (Lat2, Long2), the rotation conversion is a task that converts the area location information and the area GNSS information by letting the area location information and the area GNSS information to correspond to each other, respectively.

The area location information is represented as the area relative-coordinate system, but the area GNSS information based on the GNSS is represented as the earth coordinate system. Accordingly, the rotation conversion is necessary in order to let the area location information to correspond to the area GNSS information.

Furthermore, the size conversion is a conversion task that is performed in order to correct a distance difference between the area location information and the area GNSS information. The area location information is represented in the area relative-coordinate system. Pieces of distance information that is obtained based on the coordinate values (a, b) and (c, d) and pieces of distance information that is obtained based on the area GNSS information (Lat1, Long1) and (Lat2, Long2) correspond to each other, respectively, but are multiplicatively proportional to each other. Accordingly, size magnification and the size conversion that let the pieces of distance information to correspond to each other are necessary. In this case, the size conversion may also be identically applied to a z axis coordinate value “z” of the first location information.

In this case, if a corresponding area is a building, the z axis coordinate value may correspond to information on a discontinuous floor in FIG. 4 or the altitude of a corresponding floor through actual measurement. That is, a discontinuous value, such as floor information, may be calculated by considering the structure of a GNSS signal shadow area, such as a building. To this end, in an embodiment of the present disclosure, a structure within a building may be previously collected and the altitude of each floor may be extracted, by using a method using an architectural drawing and scan information within a building.

For example, the floor information is provided as a discontinuous value, such as the first floor, the second floor, or the third floor. In this case, an inter-floor distance may be provided as having the same or different predetermined altitude (e.g., 20 m). As another example, the floor information may be a value that is represented on the basis of an above sea level that is actually measured in an architectural drawing (e.g., the second floor=620 m). In this case, if a step is present within the same floor, a plurality of zones on the same floor may be grouped, and may be provided as representative values (e.g., a first zone (e.g., 619 m) of the second floor and a second zone (e.g., 622 m) of the second floor) that are actually measured for each group. As still another example, the floor information may be represented by applying the distance (e.g., 20 m) between the floors, which has the predetermined altitude, on the basis of the above sea level (e.g., 600 m) for the first floor of a building that is actually measured.

Through such rotation conversion and size conversion processes, corresponding area location information and corresponding area GNSS information may be made to correspond to each other. As a result, the first location information (x₁, y₁, z) may be converted into the second location information (xₗₐₜ, y_{long}, z_{altitude}), that is a virtual GNSS value. In this case, z_{altitude}, that is, the z axis value of the second location information, may be provided as only a floor identically with floor information Z, may be provided as a value that is represented on the basis of the above sea level that is actually measured, or may be provided as an altitude value in which the above sea level and an inter-floor distance have been combined. For example, if the floor information is provided as the second floor, z_{altitude} may be indicated to correspond to 620 m by adding the inter-floor distance information 20 m to the above sea level 600 m for the first floor. The floor information is provided as the second floor with respect to a user or a system, but detailed information thereof may be provided as being 620 m.

The first location information may be converted into the second location information by performing the size conversion according to Equation 1 and the rotation conversion according to Equation 2 on the first location information. If the size conversion according to Equation 1 is applied, the second location information, that is, the results of the enlargement or reduction of the first location information, may be obtained by applying S_{X}, that is, a size conversion ratio in an x axis direction, and S_{Y}, that is, a size conversion ratio in a y axis direction, to the first location information. Furthermore, if the rotation conversion according to Equation 2 is applied, the second location information may be obtained by rotating the first location information counterclockwise by θ. For reference, in Equation 2, it has been indicated that the first location information is rotated counterclockwise. In the description of the present disclosure, the size conversion and the rotation conversion may be separately described, but this is for convenience of description. The size conversion and the rotation conversion may be simultaneously performed through one equation.

$$Equation 1$$

$$[ \begin{matrix}{X}_{new} \\ {Y}_{new}\end{matrix} ] = [ \begin{matrix}{S}_{X} & 0 \\ b & {S}_{Y}\end{matrix} ] \times [ \begin{matrix}{X}_{old} \\ {Y}_{old}\end{matrix} ] \qquad ( 1 )$$

$$Equation 2$$

$$[ \begin{matrix}{X}^{′} \\ {Y}^{′}\end{matrix} ] = [ \begin{matrix}cos θ & sin θ \\ - sin θ & cos θ\end{matrix} ] \times [ \begin{matrix}X \\ Y\end{matrix} ] \qquad ( 2 )$$

The second location information converted as described above may be provided to a server or a user terminal that requires the second location information. The server or the user terminal, that is, the receiving side, can be provided with continuous location information that is represented as GNSS information. That is, the server or the user terminal can track a continuous location of an object based on GNSS-based location information although the object moves from outdoors to indoors (or the opposite thereof).

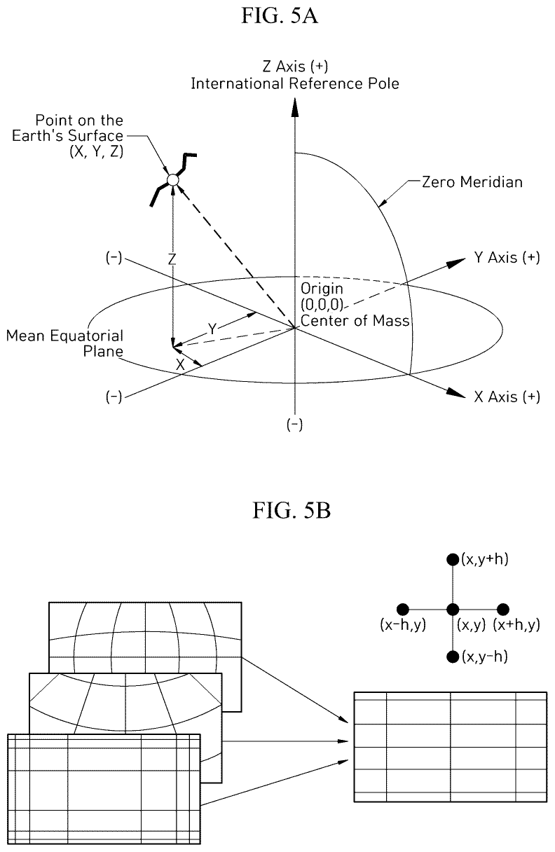

FIG. 5 is a diagram for describing contents in which approximation is applied to the second location information according to a predetermined condition in an embodiment of the present disclosure.

In an embodiment of the present disclosure, in generating the second location information, if a total area of a GNSS signal shadow area is an area greater than a preset threshold, the first location information may be converted into the second location information through approximation by which a finite element method or a finite difference method is applied to the first location information.

For example, when the area of a building is small, the curvature of the earth may be negligible. However, when a building has a large area like a large-sized shopping mall, the accuracy of location information may be reduced through only the matching of the first location information with the second location information due to the influence of the curvature of the earth. In order to solve such a problem, in an embodiment of the present disclosure, it is necessary to provide location information by considering the size or area of a building.

Furthermore, in an embodiment of the present disclosure, if a shape of a GNSS signal shadow area does not satisfy a preset curvature condition, the first location information may be converted into the second location information through approximation by which the finite element method or the finite difference method is applied to the first location information.

That is, when an appearance of a building has a curved line rather than a straight line, it is necessary to approximate the appearance of the building based on a set of several points closest to the building. To this end, in an embodiment of the present disclosure, an approximation method, such as the finite element method or the finite difference method, may be applied to the appearance of the building. When the appearance of the building is approximated as an angled figure or a straight line through the approximation process, subsequent processing, such as rotation conversion and size conversion, can be performed more accurately.

In an embodiment of the present disclosure, when a maximum possible error between an actual location and results that are derived by using a positioning technology and to which approximation has not been applied, is greater than a technical requirement level value that is set by a user or a manager, the second location information that is converted by applying approximation may be provided. Accordingly, an error can be further reduced, and more accurate location information can be provided.

In other words, if approximation, such as the finite element method or the finite difference method, needs to be applied due to a reason, such as a shape or area of a building, more accurate location information can be provided to a user, by checking a maximum possible error between results to which the approximation has not been applied and an actual location and providing results to which the approximation has been applied when the maximum possible error is greater than a technical requirement level value in order to minimize an error of location information that is provided to the user.

In an embodiment of the present disclosure, the first location information, area location information, and area GNSS information of an object according to the positioning of a GNSS signal shadow area have been described as being obtained through all of location information systems, but the present disclosure is not essentially limited thereto.

For example, if an object is a vehicle, area location information and area GNSS information may be received from the vehicle. That is, when the vehicle moves from outdoors to indoors (or the opposite thereof), a GNSS value at each location of a specific point (e.g., a first point or a second point) may be received from the vehicle.

Accordingly, the system for generating location information may convert the first location information of the vehicle according to an indoor positioning scheme into the second location information, based on the area location information and the area GNSS information corresponding to the first point and the second point, and may provide the second location information.

In another embodiment of the present disclosure, a maximum error to be compared with a technical requirement level value may be determined based on data that are collected in a predetermined time interval (e.g., one week or one month).

For example, in the first 1^{st} time interval, a basic value and a technical requirement level value that are set by default are applied. A first maximum error between first results (i.e., results on which approximation has not been applied) and second results (i.e., an actual location) of an object, which are collected in the 1^{st} time interval is calculated. Furthermore, the first maximum error may be applied when the second location information of the object in the 2^{nd} time interval is provided. Likewise, a second maximum error between first results and second results of the object, which are collected in the 2^{nd} time interval, may be calculated, and may be applied when the second location information of the object in the third time interval is provided.

As another example, in the first 1^{st} time interval, a basic value and a technical requirement level value that are set by default are applied. In the 2^{nd} time interval, the second location information of an object may be provided by applying a first maximum error. Thereafter, after a second maximum error in the 2^{nd} time interval is calculated, the first maximum error and the second maximum error are compared. When the results of the comparison are greater than a preset first threshold, an error average value of the object in the 1^{st} time interval and an error average value of the object in the 2^{nd} time interval are calculated. When each of the error average values is smaller than a preset second threshold, a maximum error that is further matched with a basic value that has already been applied may be applied to a 3^{rd} time interval, that is, a next time interval because there is a possibility that any one of the first and second maximum errors will be an outlier.

In contrast, when the results of the comparison between the first maximum error and the second maximum error are equal to or smaller than the preset first threshold, the second maximum error having recency may be applied to the 3^{rd} time interval, that is, a next time interval.

As described above, in an embodiment of the present disclosure, more accurate location information can be provided by removing a value having a good possibility that the value will be an outlier according to a time interval.

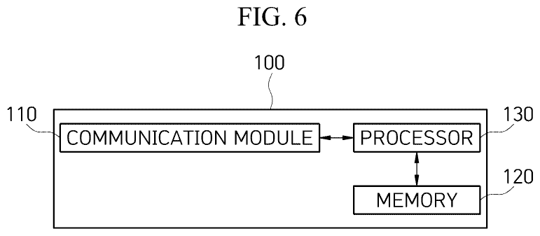

In the aforementioned description, each of steps S110 to S140 may be further divided into additional steps or the steps may be combined into smaller steps depending on an implementation example of the present disclosure. Furthermore, some of the steps may be omitted, if necessary, and the sequence of the steps may be changed. Furthermore, although contents are omitted, the contents of FIGS. 1 to 5 may also be applied to the system 100 for generating location information in FIG. 6.

FIG. 6 is a block diagram of the system 100 for generating location information according to an embodiment of the present disclosure.

The system 100 for generating location information according to an embodiment of the present disclosure includes a communication module 110, memory 120, and a processor 130.

The communication module 110 transmits and receives data to and from a user terminal or a management server, and also transmits and receives data to and from a camera or a positioning sensor for the positioning of a GNSS signal shadow area. The communication module 110 may include both a wired communication module and a wireless communication module. The wired communication module may be implemented as a power line communication device, a telephone line communication device, cable home (MoCA), Ethernet, IEEE1294, an integrated wired home network, or an RS-485 controller. Furthermore, the wireless communication module may be implemented as a wireless LAN (WLAN), Bluetooth, an HDR WPAN, UWB, ZigBee, impulse radio, a 60 GHz WPAN, binary-CDMA, a wireless USB technology, or a wireless HDMI technology.

The memory 120 stores a program for generating location information of a still or moving object, which is placed in a GNSS signal shadow area. The processor 130 executes the program stored in the memory 120.

In this case, the memory 120 commonly refers to a nonvolatile storage device that retains information stored therein although power is not supplied to the nonvolatile storage device and a volatile storage device. For example, the memory 120 may include NAND flash memory such as a compact flash (CF) card, a secure digital (SD) card, a memory stick, a solid-state drive (SSD), and a micro SD card, a magnetic computer memory device such as a hard disk drive (HDD), and an optical disc drive such as CD-ROM and DVD-ROM.

The processor 130 generates the first location information based on an area relative-coordinate system, based on results that are measured by a predetermined positioning scheme with respect to a still or moving object. Furthermore, the processor 130 obtains area location information according to the area relative-coordinate system and area GNSS information in a GNSS coordinate system, which is matched with the area location information, converts the first location information into the second location information, that is, a virtual GNSS location value continuous to the GNSS, based on the results of matching between the area location information and the area GNSS information, and provides the converted second location information.

The method of generating location information in a GNSS signal shadow area according to an embodiment of the present disclosure may be implemented in the form of a program (or application) in order to be executed by being combined with a computer, that is, hardware, and may be stored in a medium.

The aforementioned program may include a code coded in a computer language, such as C, C++, JAVA, Ruby, or a machine language which is readable by a processor (CPU) of a computer through a device interface of the computer in order for the computer to read the program and execute the methods implemented as the program. Such a code may include a functional code related to a function, etc. That defines functions necessary to execute the methods, and may include an execution procedure-related control code necessary for the processor of the computer to execute the functions according to a given procedure. Furthermore, such a code may further include a memory reference-related code indicating at which location (address number) of the memory inside or outside the computer additional information or media necessary for the processor of the computer to execute the functions needs to be referred. Furthermore, if the processor of the computer requires communication with any other remote computer or server in order to execute the functions, the code may further include a communication-related code indicating how the processor communicates with the any other remote computer or server by using a communication module of the computer and which information or media needs to be transmitted and received upon communication.

The stored medium means a medium, which semi-permanently stores data and is readable by a device, not a medium storing data for a short moment like a register, cache, or a memory. Specifically, examples of the stored medium include ROM, RAM, CD-ROM, a magnetic tape, a floppy disk, optical data storage, etc., but the present disclosure is not limited thereto. That is, the program may be stored in various recording media in various servers which may be accessed by a computer or various recording media in a computer of a user. Furthermore, the medium may be distributed to computer systems connected over a network, and a code readable by a computer in a distributed way may be stored in the medium.

The description of the present disclosure is illustrative, and a person having ordinary knowledge in the art to which the present disclosure pertains will understand that the present disclosure may be easily modified in other detailed forms without changing the technical spirit or essential characteristic of the present disclosure. Accordingly, it should be construed that the aforementioned embodiments are only illustrative in all aspects, and are not limitative. For example, elements described in the singular form may be carried out in a distributed form. Likewise, elements described in a distributed form may also be carried out in a combined form.

The scope of the present disclosure is defined by the appended claims rather than by the detailed description, and all changes or modifications derived from the meanings and scope of the claims and equivalents thereto should be interpreted as being included in the scope of the present disclosure.

What is claimed is:

1. A method of generating location information in a global navigation satellite system (GNSS) signal shadow area, the method performed by a computer comprising:
generating first location information based on an area relative-coordinate system corresponding to a GNSS signal shadow area, based on results that are measured by a predetermined positioning scheme with respect to a still or moving object placed in the GNSS signal shadow area;
obtaining area location information according to the area relative-coordinate system and area GNSS information in a GNSS coordinate system, which is matched with the area location information;
converting the first location information into second location information that is a virtual GNSS location value continuous to the GNSS, based on results of matching between the area location information and the area GNSS information; and
providing the converted second location information.

2. The method of claim 1, wherein the generating of the first location information based on the area relative-coordinate system comprises generating the first location information of the still or moving object in the area relative-coordinate system, based on an image or sensing data that are obtained by a camera or a predetermined sensor installed in the GNSS signal shadow area.

3. The method of claim 1, further comprising generating a map database by mapping area location information corresponding to the GNSS signal shadow area and GNSS information corresponding to the area location information.

4. The method of claim 1, wherein the converting of the first location information into the second location information comprises performing rotation conversion and size conversion on the first location information, based on results of matching between a plurality of coordinate values included in the area location information according to the area relative-coordinate system and a plurality of GNSS values included in the area GNSS information in the GNSS coordinate system.

5. The method of claim 1, wherein the converting of the first location information into the second location information comprises converting the first location information into the second location information by performing approximation to which a finite element method or a finite difference method has been applied on the first location information in at least one of a case in which a total area of the GNSS signal shadow area is an area greater than a preset threshold and a case in which a shape of the GNSS signal shadow area does not satisfy a preset curvature condition.

6. The method of claim 5, wherein the providing of the converted second location information comprises providing the converted second location information by applying the approximation when a maximum possible error between results on which the approximation has not been applied and an actual location is greater than a preset technical requirement level value.

7. A system for generating location information in a global navigation satellite system (GNSS) signal shadow area, the system comprising:
memory in which a program for generating location information of a still or moving object placed in a GNSS signal shadow area has been stored; and
a processor configured to, when the program stored in the memory is executed,
generate first location information based on an area relative-coordinate system corresponding to the GNSS signal shadow area based on results that are measured by a predetermined positioning scheme with respect to the still or moving object,
obtain area location information according to the area relative-coordinate system and area GNSS information in a GNSS coordinate system, which is matched with the area location information,
convert the first location information into second location information that is a virtual GNSS location value continuous to the GNSS, based on results of matching between the area location information and the area GNSS information, and
provide the converted second location information.
